(19) United States
(12) Patent Application Publication
(10) Pub. No.: US 2024/0185536 A1
(43) Pub. Date: Jun. 6, 2024

(54) OBJECT DEPTH ESTIMATION PROCESSES WITHIN IMAGING DEVICES

(71) Applicant: QUALCOMM INCORPORATED, San Diego, CA (US)

(72) Inventors: Yen-Yi WU, Taipei City (TW); Yushuo Liu, Tainan City (TW); Hsien-Tzu Cheng, Taipei City (TW); Anirudh Radhakrishnan, San Diego, CA (US)

(21) Appl. No.: 18/074,326

(22) Filed: Dec. 2, 2022

(51) Int. Cl. G06T 19/00; G06T 7/50; G06T 15/00

(52) U.S. Cl. CPC G06T 19/006; G06T 7/50; G06T 15/00

(57) ABSTRACT

Methods, systems, and apparatuses are provided to determine object depth within captured images. For example, an imaging device, such as a VR or AR device, captures an image. The imaging device applies a first encoding process to the image to generate a first set of features. The imaging device also generates a sparse depth map based on the image, and applies a second encoding process to the sparse depth map to generate a second set of features. Further, the imaging device applies a decoding process to the first set of features and the second set of features to generate predicted depth values. In some examples, the decoding process receives skip connections from layers of the second encoding process as inputs to corresponding layers of the decoding process. The imaging device generates an output image, such as a 3D image, based on the predicted depth values.

### BACKGROUND

### Field of the Disclosure

This disclosure relates generally to imaging devices and, more specifically, to object depth estimation using machine learning processes in imaging devices.

### Description of Related Art

Imaging devices, such as virtual reality devices, augmented reality devices, cellular devices, tablets, and smart devices may use various signal-processing techniques to render three-dimensional (3D) images. For example, an imaging device may capture an image, and may apply conventional image processing techniques to the captured image to reconstruct a 3D image. In some examples, an imaging device may include a depth sensor to determine the depth of objects in a field-of-view of a camera of the imaging device. In some examples, an imaging device may execute a depth estimation algorithm captured images (e.g., left-eye and right-eye images) to determine object depth. There are opportunities to improve depth estimation within imaging device.

### SUMMARY

According to one aspect, a method by an imaging device includes receiving three dimensional feature points from a six degrees of freedom (6Dof) tracker. The method also includes generating sparse depth values based on the three dimensional feature points. Further, the method includes generating predicted depth values based on an image and the sparse depth values. The method also includes storing the predicted depth values in a data repository.

According to another aspect, an apparatus comprises a non-transitory, machine-readable storage medium storing instructions, and at least one processor coupled to the non-transitory, machine-readable storage medium. The at least one processor is configured to execute the instructions to receive three dimensional feature points from a six degrees of freedom (6Dof) tracker. The at least one processor is also configured to execute the instructions to generate sparse depth values based on the three dimensional feature points. Further, the at least one processor is configured to execute the instructions to generate predicted depth values based on an image and the sparse depth values. The at least one processor is also configured to execute the instructions to store the predicted depth values in a data repository.

According to another aspect, a non-transitory, machine-readable storage medium storing instructions that, when executed by at least one processor, causes the at least one processor to perform operations that include receiving three dimensional feature points from a six degrees of freedom (6Dof) tracker. The operations also include generating sparse depth values based on the three dimensional feature points. Further, the operations include generating predicted depth values based on an image and the sparse depth values. The operations also include storing the predicted depth values in a data repository.

### BRIEF DESCRIPTION OF DRAWINGS

FIG. 1 is a block diagram of an exemplary imaging device, according to some implementations;

FIGS. 2 and 3 are block diagrams illustrating exemplary portions of the imaging device of FIG. 1, according to some implementations;

FIG. 4 illustrates a diagram of a machine learning model according to some implementations;

FIG. 5 is a flowchart of an exemplary process for determining depth values for objects within an image, according to some implementations;

FIG. 6 is a flowchart of an exemplary process for rendering an image based on determined depth values, according to some implementations; and

FIG. 7 is a flowchart of an exemplary process for training a machine learning process, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

In some implementations, an imaging device projects three dimensional feature points from tracking information to two dimensional feature points to generate a sparse depth map. The image device applies a machine learning process to the sparse depth map and a color image to generate a refined depth map. For example, an imaging device, such as a VR or AR device, captures an image. The imaging device applies a first encoding process to the image to generate a first set of features. The imaging device also generates a sparse depth map based on the image, and applies a second encoding process to the sparse depth map to generate a second set of features. Further, the imaging device applies a decoding process to the first set of features and the second set of features to generate predicted depth values. In some examples, the decoding process receives skip connections from layers of the second encoding process as inputs to corresponding layers of the decoding process. The imaging device generates an output image, such as a 3D image, based on the predicted depth values.

In some implementations, an imaging device may include one or more cameras, one or more sensors (e.g., a gyroscope sensor, an accelerometer, etc.), an image encoder engine, a sparse encoder engine, and a decoder engine. In some examples, one or more of the image encoder engine, sparse encoder engine, and decoder engine may include instructions executed by one or more processors. Further, each camera may include, for example, one or more lenses and one or more imaging sensors. Each camera may also include one or more lens controllers that can adjust a position of the lenses. The imaging device may capture image data from each of the cameras. For example, the imaging device may capture first image data from a first camera, and may also capture second image data from a second camera. In some examples, the first camera and second camera may collectively establish a stereo camera (e.g., left and right cameras).

The image encoder engine, when executed by one or more processors, may receive image data characterizing an image captured by one or more of the cameras, and may generate image encoder feature data (e.g., image feature values) characterizing features of the image data. For example, the executed image encoder engine may receive the image data, and apply an encoding process (e.g., feature extraction process) to the image data to extract a set of image features. In some examples, the executed image encoder engine establishes a neural network encoder, such as an encoder of a convolutional neural network (CNN) (e.g., an Xception convolutional neural network, a CNN-based image feature extractor, or a deep neural network (DNN) encoder (e.g., a DNN or CNN-based encoder)), and applies the established encoder to the image data to extract the set of image features.

The sparse encoder engine, when executed by one or more processors, may receive sparse depth data (e.g., sparse depth values) characterizing a sparse depth map of an image, such as the image captured by the cameras, and may generate sparse encoder feature data (e.g., sparse feature values) characterizing sparse features of the image. For example, the executed sparse encoder engine may receive the sparse depth data, and may apply an encoding process to the sparse depth data to extract a set of sparse features. In some examples, the executed sparse encoder engine establishes a neural network encoder, such as an encoder of a CNN (e.g., a CNN-based sparse depth feature extractor or a deep neural network (DNN) encoder (e.g., a DNN or CNN-based encoder), and applies the established encoder to the sparse depth data to extract the sparse features. In some instances, the sparse executed encoder engine provides skip connections (e.g., outputs of one or more layers of the encoding process) to the executed decoder engine, as described further below.

The executed decoder engine, when executed by one or more processors, may receive a set of image features (e.g., such as those generated by the encoder engine) and a set of sparse features (e.g., such as those generated by the sparse encoder engine), and may generate depth map data (e.g., depth map values) characterizing a predicted depth map for an image (e.g., such as for the image captured by the cameras). For example, the executed decoder engine may receive the image encoder feature data generated by the executed image encoder engine, and the sparse encoder feature data generated by the executed sparse encoder engine. Further, the executed decoder engine may apply a decoding process to the image encoder feature data and the sparse encoder feature data to generate a predicted depth map. In some examples, the executed decoder engine establishes a decoder of a neural network, such as a decoder of the deep neural network established by the executed encoder engine (e.g., a CNN-based decoder or a DNN-based decoder), and applies the established decoder to the image encoder feature data and the spare encoder feature data to generate the predicted depth map (e.g., to generate predicted depth values from the image and the sparse features). In some examples, the executed decoder engine receives skip connections from the executed sparse encoder, and inputs the skip connections to corresponding layers of the decoding process.

In some examples, the imaging device includes one or more of a head tracker engine, a sparse point engine, and a render engine. In some examples, one or more of the head tracker engine, the sparse point engine, and the render engine may include instructions that can be executed by one or more processors. The head tracker engine, when executed by one or more processors, may receive image data characterizing an image captured by one or more of the cameras, and may generate feature point data characterizing features of the image. For instance, the executed head tracker engine may apply one or more processes (e.g., a trained machine learning process) to the received image data and, in some instances, to additional sensor data, to generate the feature point data. In some examples, the image captured by the camera is a monochrome image (e.g., greyscale image, greyscale image in each of three color channels), and thus the generated features are based on the monochrome image. In some examples, the executed head tracker engine may apply the one or more processes to sensor data, such as accelerometer and/or gyroscope data, to generate the feature point data. The executed head tracker engine, in some instances, may also generate pose data characterizing a pose of a user, such as a user of the imaging device. In addition, the determined pose may be temporally associated with a time of capture of an image, such as the image captured by the camera. In some examples, the head tracker engine includes instructions that, when executed by the one or more processors, provides six degrees of freedom (6Dof) tracking functionality. For instance, the executed head tracker engine can detect motion of a user's head including yaw, pitch, roll, and movement within a space including left, right, backwards, forwards, up, and down, based on, for instance, image data and/or sensor data.

The sparse point engine, when executed by one or more processors, may receive the feature point data (e.g., keypoints) from the executed head tracker engine, and may generate sparse depth values characterizing a sparse depth map based on the feature point data. For example, the executed sparse point engine may apply a depth estimation process to the feature point data to generate the sparse depth values characterizing the sparse depth map. In some instances, the executed sparse encoder engine operates on the sparse depth values generated by the executed sparse point engine.

When executed by one or more processors, the render engine may receive the depth map data (e.g., the predicted depth map) from the executed decoder engine, and may render an output image based on the depth map data. For example, the executed render engine may perform one or more mesh rendering processes to generate mesh data characterizing a mesh of an image, such as the image captured by one of the cameras, based on the depth map data. In some examples, the executed render engine may perform one or more plane estimation processes to generate plane data characterizing one or more planes based on the mesh data.

Among other advantages, the imaging device may not require depth sensors, thereby reducing cost and power consumption, as well as reducing a size and weight of the imaging device. Further, the imaging device may more accurately, and efficiently, generate depth maps than conventional depth estimation methods.

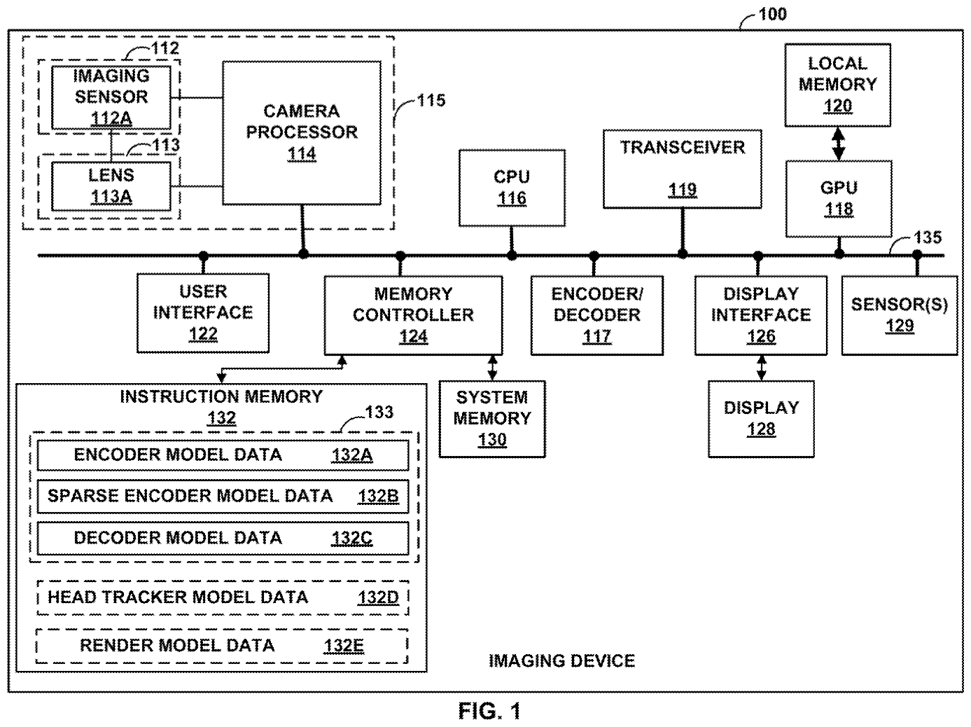

FIG. 1 is a block diagram of an exemplary imaging device 100. The functions of imaging device 100 may be implemented in one or more processors, one or more field-programmable gate arrays (FPGAs), one or more application-specific integrated circuits (ASICs), one or more state machines, digital circuitry, any other suitable circuitry, or any suitable hardware. Imaging device 100 may perform one or more of the exemplary functions and processes described in this disclosure. Examples of imaging device 100 include, but are not limited to, extended reality devices (e.g., a virtual reality device (e.g., a virtual reality headset), an augmented reality device (e.g., augmented reality glasses), a mixed reality device, etc.), a camera, a video recording device such as a camcorder, a mobile device such as a tablet computer, a wireless communication device (such as, e.g., a mobile telephone, a cellular telephone, etc.), a handheld device, such as a portable video game device or a personal digital assistant (PDA), or any device that may include one or more cameras.

As illustrated in the example of FIG. 1, imaging device 100 may include one or more imaging sensors 112, such as imaging sensor 112A, one or more lenses 113, such as lens 113A, and one or more camera processors, such as camera processor 114. Camera processor 114 may also include a lens controller that is operable to adjust a position of one or more lenses 113, such as 113A. In some instances, the camera processor 114 may be an image signal processor (ISP) that employs various image processing algorithms to process image data (e.g., as captured by corresponding ones of these lenses and sensors). For example, the camera processor 114 may include an image front end (IFE) and/or an image processing engine (IPE) as part of a processing pipeline. Further, a camera 115 may refer to a collective device including one or more imaging sensors 112, one or more lenses 113, and one or more camera processors 114.

In some examples, one of or more of imaging sensors 112 may be allocated for each of lenses 113. Further, in some examples, one or more of imaging sensors 112 may be allocated to a corresponding one of lenses 113 of a respective, and different, lens type (e.g., a wide lens, ultra-wide lens, telephoto lens, and/or periscope lens, etc.). For instance, lenses 113 may include a wide lens, and a corresponding one of imaging sensors 112 having a first size (e.g., 108 MP) may be allocated to the wide lens. In other instance, lenses 113 may include an ultra-wide lens, and a corresponding one of imaging sensors 112 having a second, and different, size (e.g., 16 MP) may be allocated to the ultra-wide lens. In another instance, lenses 113 may include a telephoto lens, and a corresponding one of imaging sensors 112 having a third size (e.g., 12 MP) may be allocated to the telephoto lens.

In an illustrative example, a single imaging device 100 may include two or more cameras (e.g., two or more of camera 115), and at least two of the cameras include image sensors (e.g., imaging sensors 112) having a same size (e.g., two 12 MP sensors, three 108 MP sensors, three 12 MP sensors, two 12 MP sensors and a 108 MP sensor, etc.). Further, in some examples, a single image sensor, e.g., imaging sensor 112A, may be allocated to multiple ones of lenses 113. Additionally, or alternatively, each of imaging sensors 112 may be allocated to a different one of lenses 113, e.g., to provide multiple cameras to imaging device 100.

In some examples, imaging device 100 may include multiple cameras 115 (e.g., a VR device or AR device having multiple cameras, a mobile phone having one or more front-facing cameras and one or more rear-facing cameras). For instance, imaging device 100 may be a VR headset that includes a first camera, such as camera 115, having a first field of view and located in a first portion (e.g., corner) of the headset, a second camera having a second field of view and located in a second portion of the headset, a third camera having a third field of view and located in a second portion of the headset, and a fourth camera having a fourth field of view and located in a fourth portion of the headset. Each camera 115 may include an imaging sensor 112A with a corresponding resolution, such as 12 MP, 16 MP, or 108 MP.

In some examples, imaging device 100 may include multiple cameras facing in different directions. For example, imaging device 100 may include dual “front-facing” cameras. Additionally, in some examples, imaging device 100 may include a “front-facing” camera, such as camera 115, and a “rear-facing” camera. In other examples, imaging device 100 may include dual “front-facing” cameras, which may include camera 115, and one or more “side-facing” cameras. In further examples, imaging device 100 may include three “front-facing” cameras, such as camera 115. In yet other examples, imaging device 100 may include three “front-facing” cameras, and one, two, or three “rear-facing” cameras. Further, a person of skill in the art would appreciate that the techniques of this disclosure may be implemented for any type of camera and for any number of cameras of imaging device 100.

Each of the imaging sensors 112, including imaging sensor 112A, may represent an image sensor that includes processing circuitry, an array of pixel sensors (e.g., pixels) for capturing representations of light, memory, an adjustable lens (such as lens 113), and an actuator to adjust the lens. By way of example, imaging sensor 112A may be associated with, and may capture images through, a corresponding one of lenses 113, such as lens 113A. In other examples, additional, or alternate, ones of imaging sensors 112 may be associated with, and capture images through, corresponding additional ones of lenses 113.

In some instances, imaging sensors 112 may include a monochrome sensor (e.g., a “clear” pixel sensor) and/or a color sensor (e.g., a Bayer sensor). For example, a monochrome pixel sensor may be established through a disposition of a monochrome filter over imaging sensor 112A. Further, in some examples, a color pixel sensor may be established through a disposition of a color filter, such as a Bayer filter, disposed over imaging sensor 112A, or through a disposition of a red filter, a green filter, or a blue filter may over imaging sensor 112A. Various other filter patterns exist, such as red, green, blue, white (“RGBW”) filter arrays; cyan, magenta, yellow, white (CMYW) filter arrays; and/or variations thereof, including proprietary or non-proprietary filter patterns.

Further, in some examples, multiple ones of lenses 113 may be associated with, and disposed over, respective subsets of imaging sensors 112. For instance, a first subset of imaging sensors 112 may be allocated to a first one of lenses 113 (e.g., a wide lens camera, ultra-wide lens camera, telephoto lens camera, periscope lens camera, etc.), and a second subset of imaging sensors 112 may be allocated to a second one of lenses 113 distinct from the first subset. In some instances, each of lenses 113 may serve respective functions as provided by various attributes of the cameras (e.g., lens attributes, aperture attributes, angle-of-view attributes, thermal imaging attributes, etc.), and a user of imaging device 100 may leverage the various attributes of each of lenses 113 to capture one or more images or sequences of images (e.g., as in a video recording).

Imaging device 100 may further include a central processing unit (CPU) 116, one or more sensors 129, an encoder/decoder 117, a transceiver 119, a graphics processing unit (GPU) 118, a local memory 120 of GPU 118, a user interface 122, a memory controller 124 that provides access to system memory 130 and to instruction memory 132, and a display interface 126 that outputs signals that causes graphical data to be displayed on a display 128.

A sensor 129 may be, for example, a gyroscope sensor (e.g., gyroscope) that is operable to measure a rotation of imaging device 100. In some examples, gyroscope sensors 129 may be distributed across the imaging device 100 to measure rotations of imaging device 100 around one or more axis of imaging device 100 (e.g., yaw, pitch, and roll). Further, each gyroscope sensor 129 may generate gyro data characterizing a measured rotation, and may store the gyro data within a memory device (e.g., internal RAM, first-in-first out (FIFO), system memory 130, etc.). For instance, the gyro data may include one or more rotation values identifying a rotation of imaging device 100. CPU 116 and/or camera processor 114 may obtain (e.g., read) the generated gyro data from each gyro sensor.

As another example, a sensor 129 may be an accelerometer that is operable to measure an acceleration of imaging device 100. In some examples, imaging device 100 may include multiple accelerometers 129 to measure accelerations in multiple directions. For instance, each accelerometer may generate acceleration data characterizing an acceleration in one or more directions, and may store the acceleration data within a memory device, such as an internal memory or system memory 130.

Additionally, in some instances, imaging device 100 may receive user input via user interface 122 and, in response to the received user input, CPU 116 and/or camera processor 114 may activate respective ones of lenses 113, or combinations of lenses 113. For example, the received user input may corresponding a user selection of lens 113A (e.g., a fisheye lens), and based on the received user input, CPU 116 may select an initial one of lenses 113 to activate and additionally, or alternatively, may transition from the initially selected lens 113A to another one of lenses 113.

In other examples, CPU 116 and/or camera processor 114 may detect an operating condition that satisfies certain lens-selection criteria (e.g., digital zoom level satisfying a predefined camera transition threshold, a change in lighting conditions, input from a user calling for a particular lens 13, etc.), and may select the initial one of lenses 113, such as lens 113A, for activation based on the detected operating condition. For example, CPU 116 and/or camera processor 114 may generate and provide a lens adjustment command to lens controller 114A to adjust a position of a corresponding lens 113A. The lens adjustment command may identify a position to adjust the lens 113A to, or an amount by which to adjust a current lens position by, for example. In response, lens controller 114A may adjust the position of the lens 113A in accordance with the lens adjustment command. In some examples, imaging device 100 may include multiple ones of camera 115, which may collectively capture one synthetic image or stream of synthetic images, such that camera processor 114 or CPU 116 may process one synthetic image or stream of synthetic images based on image data captured from imaging sensors 112. In some examples, the operating condition detected by CPU 116 and/or camera processor 114 includes a rotation as determined based on rotation data or acceleration data received from a sensor 129.

In some examples, each of lenses 113 and imaging sensors 112 may operate collectively to provide various optical zoom levels, angles of view (AOV), focal lengths, and FOVs. Further, light guides may be used to direct incident light from lenses 113 to a respective one of imaging sensors 112, and examples of the light guides may include, but are not limited to, a prism, a moving prism, or one or more mirrors. For instance, light received from lens 113A may be redirected from imaging sensor 112A toward another one of imaging sensors 112. Further, in some instances, camera processor 114 may perform operations that cause a prism to move and redirect light incident on lens 113A in order to effectively change the focal length for the received light.

Further, as illustrated in FIG. 1, a single camera processor, such as camera processor 114, may be allocated to and interface with all, or a selected subset, of imaging sensors 112. In other instances, multiple camera processors may be allocated to and interface with all, or a selected subset, of imaging sensors 112, and each of the camera processors may coordinate with one another to efficiently allocate processing resources to the all, or the selected subset, of imaging sensors 112. For example, and through the execution of stored instructions, camera processor 114 may implement multiple processing algorithms under various circumstances to perform digital zoom operations or other image processing operations.

Although the various components of imaging device 100 are illustrated as separate components, in some examples, the components may be combined to form a system on chip (SoC). As an example, camera processor 114, CPU 116, GPU 118, and display interface 126 may be implemented on a common integrated circuit (IC) chip. In some examples, one or more of camera processor 114, CPU 116, GPU 118, and display interface 126 may be implemented in separate IC chips. Various other permutations and combinations are possible, and the techniques of this disclosure should not be considered limited to the example of FIG. 1.

System memory 130 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

System memory 130 may store program modules and/or instructions and/or data that are accessible by camera processor 114, CPU 116, and GPU 118. For example, system memory 130 may store user applications (e.g., instructions for a camera application) and resulting images from camera processor 114. System memory 130 may also store rendered images, such as three-dimensional (3D) images, rendered by one or more of camera processor 114, CPU 116, and GPU 118. System memory 130 may additionally store information for use by and/or generated by other components of imaging device 100. For example, system memory 130 may act as a device memory for camera processor 114.

Similarly, GPU 118 may store data to, and read data from, local memory 120. For example, GPU 118 may store a working set of instructions to local memory 120, such as instructions loaded from instruction memory 132. GPU 118 may also use local memory 120 to store dynamic data created during the operation of imaging device 100. Examples of local memory 120 include one or more volatile or non-volatile memories or storage devices, such as RAM, SRAM, DRAM, EPROM, EEPROM, flash memory, a magnetic data media, a cloud-based storage medium, or an optical storage media.

Instruction memory 132 may store instructions that may be accessed (e.g., read) and executed by one or more of camera processor 114, CPU 116, and GPU 118. For example, instruction memory 132 may store instructions that, when executed by one or more of camera processor 114, CPU 116, and GPU 118, cause one or more of camera processor 114, CPU 116, and GPU 118 to perform one or more of the operations described herein. For instance, instruction memory 132 can include instructions 133 that, when executed by one or more of camera processor 114, CPU 116, and GPU 118, cause one or more of camera processor 114, CPU 116, and GPU 118 to establish one or more machine learning processes 133 to generate depth values characterizing a predicted depth map.

For example, encoder model data 132A can include instructions that, when executed by one or more of camera processor 114, CPU 116, and GPU 118, cause one or more of camera processor 114, CPU 116, and GPU 118 to establish a first encoding process, and apply the established first encoding process to an image, such as an image captured by camera 115, to generate a set of image features.

Instruction memory 132 can also include sparse encoder model data 132B that can include instructions that, when executed by one or more of camera processor 114, CPU 116, and GPU 118, cause one or more of camera processor 114, CPU 116, and GPU 118 to establish a second encoding process, and apply the established second encoding process to a sparse depth map to generate a set of sparse features.

Further, instruction memory 132 can include decoder model data 132C that can include instructions that, when executed by one or more of camera processor 114, CPU 116, and GPU 118, cause one or more of camera processor 114, CPU 116, and GPU 118 to establish a decoding process, and apply the established decoding process to the set of image features and the set of sparse features to generate a predicted depth map.

Instruction memory 132 can also include head tracker model data 132D that can include instructions that, when executed by one or more of camera processor 114, CPU 116, and GPU 118, cause one or more of camera processor 114, CPU 116, and GPU 118 to establish a feature extraction process, and apply the feature extraction process to an image, such as an image captured by camera 115, to generate feature point data characterizing features of the image. The head tracker model data 132D can also include instructions that, when executed by one or more of camera processor 114, CPU 116, and GPU 118, cause one or more of camera processor 114, CPU 116, and GPU 118 to generate pose data characterizing a pose of a user, based on the feature point data. In some examples, head tracker model data 132D includes instructions that, when executed by one or more of camera processor 114, CPU 116, and GPU 118, provides six degrees of freedom (6Dof) tracking functionality. For instance, when executing head tracker model data 132D, the one or more of camera processor 114, CPU 116, and GPU 118 can detect motion of a user's head including yaw, pitch, roll, and movement within a space including left, right, backwards, forwards, up, and down.

Instruction memory 132 can also include render model data 132E that can include instructions that, when executed by one or more of camera processor 114, CPU 116, and GPU 118, cause one or more of camera processor 114, CPU 116, and GPU 118 to render an output image based on the predicted depth map generated by the decoding process. In some examples, render model data 132E can include instructions that, when executed by one or more of camera processor 114, CPU 116, and GPU 118, cause one or more of camera processor 114, CPU 116, and GPU 118 to render the output image based on the predicted depth map and the pose data. For example, in some instances, render model data 132E includes instructions that, when executed by one or more of camera processor 114, CPU 116, and GPU 118, cause one or more of camera processor 114, CPU 116, and GPU 118 to establish a mesh rendering process, and apply the established mesh rendering process to the predicted depth map and the pose data to generate one or more of mesh data characterizing a mesh of an image, and plane data characterizing one or more planes of the image.

Instruction memory 132 may also store instructions that, when executed by one or more of camera processor 114, CPU 116, and GPU 118, cause one or more of camera processor 114, CPU 116, and GPU 118 to perform additional image processing operations, such as one or more of automatic gain (AG), automatic white balance (AWB), color correction, or zoom operations, to captured images.

The various components of imaging device 100, as illustrated in FIG. 1, may be configured to communicate with each other across bus 135. Bus 135 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus), or another type of bus or device interconnect. It is to be appreciated that the specific configuration of components and communication interfaces between the different components shown in FIG. 1 is merely exemplary, and other configurations of the components, and/or other image processing systems with the same or different components, may be configured to implement the operations and processes of this disclosure.

Memory controller 124 may be communicatively coupled to system memory 130 and to instruction memory 132. Memory controller 124 may facilitate the transfer of data going into and out of system memory 130 and/or instruction memory 132. For example, memory controller 124 may receive memory read and write commands, such as from camera processor 114, CPU 116, or GPU 118, and service such commands to provide memory services to system memory 130 and/or instruction memory 132. Although memory controller 124 is illustrated in the example of FIG. 1 as being separate from both CPU 116 and system memory 130, in other examples, some or all of the functionality of memory controller 124 may be implemented on one or both of CPU 116 and system memory 130. Likewise, some or all of the functionality of memory controller 124 may be implemented on one or both of GPU 118 and instruction memory 132.

Camera processor 114 may also be configured, by executed instructions, to analyze image pixel data and store resulting images (e.g., pixel values for each of the image pixels) to system memory 130 via memory controller 124. Each of the images may be further processed for generating a final image for display. For example, GPU 118 or some other processing unit, including camera processor 114 itself, may perform any of the machine learning processes described herein, and any color correction, white balance, blending, compositing, rotation, digital zoom, or any other operations to generate final image content for display (e.g., on display 128).

CPU 116 may comprise a general-purpose or a special-purpose processor that controls operation of imaging device 100. A user may provide input to imaging device 100 to cause CPU 116 to execute one or more software applications. The software applications executed by CPU 116 may include, for example, a VR application, an AR application, a camera application, a graphics editing application, a media player application, a video game application, a graphical user interface application or another program. For example, and upon execution by CPU 116, a camera application may allow control of various settings of camera 115, e.g., via input provided to imaging device 100 via user interface 122. Examples of user interface 122 include, but are not limited to, a pressure-sensitive touchscreen unit, a keyboard, a mouse, or an audio input device, such as a microphone. For example, user interface 122 may receive input from the user to select an object in a field-of-view of a camera 115 (e.g., for VR or AR gaming applications), adjust desired zoom levels (e.g., digital zoom levels), alter aspect ratios of image data, record video, take a snapshot while recording video, apply filters when capturing images, select a region-of-interest (ROI) for AF (e.g., PDAF), AE, AG, or AWB operations, record slow motion video or super slow motion video, apply night shot settings, and/or capture panoramic image data, among other examples.

In some examples, one or more of CPU 116 and GPU 118 cause output data (e.g., a focused image of an object, a captured image, etc.) to be displayed on display 128. In some examples, the imaging device 100 transmits, via transceiver 119, the output data to another computing device, such as a server (e.g., cloud-based server) or a user's handheld device (e.g., cellphone). For example, the imaging device 100 may capture an image (e.g., using camera 115), and may transmit the captured image to another computing device. The computing device receiving the captured image may apply any of the machine learning processes described herein to generate a depth map values characterizing a predicted depth map for the captured image, and may transmit the depth map values to imaging device 100. Imaging device 100 may render an output image (e.g., a 3D image) based on the received depth map values, and display the output image on display 128 (e.g., via display interface 126).

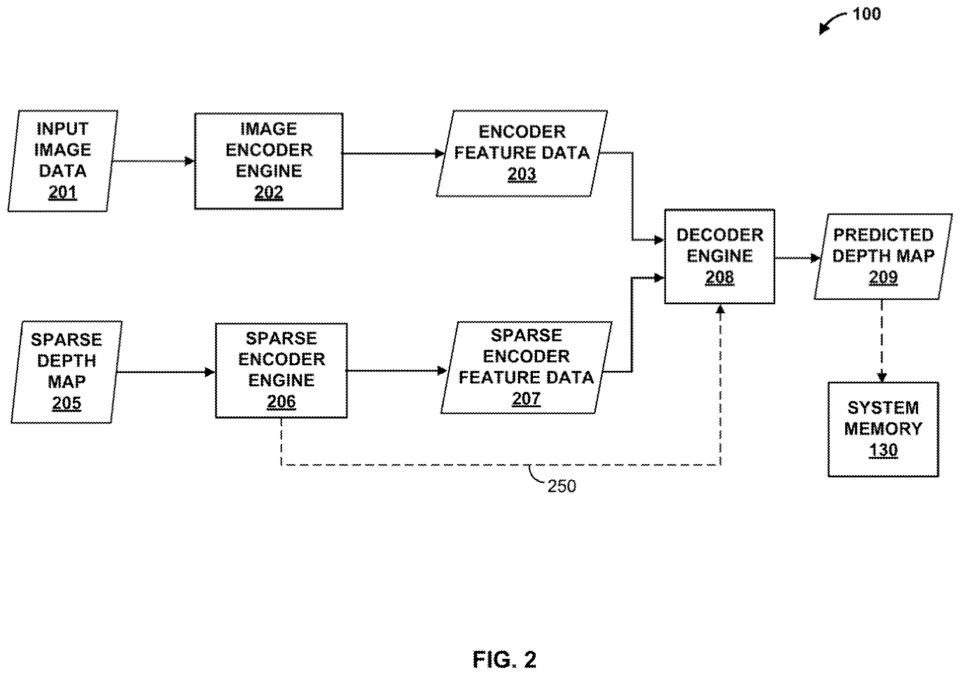

FIG. 2 is a diagram illustrating exemplary portions of the imaging device 100 of FIG. 1. In this example, imaging device 100 includes image encoder engine 202, sparse encoder engine 206, decoder engine 208, and system memory 130. As described herein, in some examples, each of image encoder engine 202, sparse encoder engine 206, and decoder engine 208 may include instructions that, when executed by one or more of camera processor 114, CPU 116, and GPU 118, cause the one or more of camera processor 114, CPU 116, and GPU 118 to perform corresponding operations. For example, image encoder engine 202 may include encoder model data 132A, sparse encoder engine 206 may include sparse encoder model data 132B, and decoder engine 208 may include decoder model data 132C. In some examples, one or more of image encoder engine 202, sparse encoder engine 206, and decoder engine 208 may be implemented in hardware, such as within one or more FPGAs, ASICs, digital circuitry, or any other suitable hardware or hardware or hardware and software combination.

In this example, image encoder engine 202 receives input image data 201. Input image data 201 may characterize an image captured by a camera, such as camera 115. In some examples, input image data 201 characterizes a color image. For example, the color image may include red, green, and blue channels, with each channel include pixels for the image for the corresponding color. In some examples, input image data 201 characterizes a monochrome image. For example, the monochrome image may include grayscale pixels for multiple color channels, such as grayscale pixel values for corresponding red, green, and blue channels.

Further, image encoder engine 202 may apply an encoding process (e.g., a first encoding process) to the input image data 201 to generate encoder feature data 203 characterizing a set of image features. In some examples, encoder engine 202 establishes an encoder of a neural network (e.g., a trained neural network), such as a CNN-based encoder (e.g., an Xception convolutional neural network) or DNN-based encoder, and applies the established encoder to the input image data 201 to generate the encoder feature data 203. For example, image encoder engine 202 may generate one or more image data vectors based on pixel values of the input image data 201, and applies the deep neural network to the image data vectors to generate encoder feature data 203 characterizing features of the image.

Sparse encoder engine 206 receives a sparse depth map 205. The sparse depth map 205 may include sparse depth values generated based on the image characterized by input image data 201. For example, and as described herein, an executed sparse point engine may generate sparse depth values for the image based on feature point data (e.g., keypoints), where the feature point data is generated by an executed head tracker engine based on the image.

Sparse encoder engine 206 applies an encoding process (e.g., a second encoding process) to the sparse depth map 205 to generate sparse encoder feature data 207 characterizing sparse features of the image. For example, sparse encoder engine 206 may establish an encoder of a neural network (e.g., a trained deep neural network), such as a CNN-based encoder or DNN-based encoder, and may apply the established encoder to the sparse depth map 205 to generate the sparse encoder feature data 207 characterizing the sparse features of the image. For example, sparse encoder engine 206 may generate one or more sparse data vectors based on sparse values of the sparse depth map 205, and may apply the deep neural network to the sparse data vectors to generate sparse encoder feature data 207 characterizing the sparse features of the image. Sparse encoder feature data 207 may include, for example, sparse feature values characterizing one or more detected features.

Decoder engine 208 receives encoder feature data 203 from the encoder engine 202, and the sparse encoder feature data 207 from the sparse encoder engine 206. Further, decoder engine 208 may apply a decoding process to the encoder feature data 203 and the sparse encoder feature data 207 to generate a predicted depth map 209 characterizing depth values for the image. For example, decoder engine 208 may establish a decoder of a neural network (e.g., a trained neural network), such as a decoder corresponding to the encoder of the deep neural network established by encoder engine 202 or sparse encoder engine 206 (e.g., a CNN-based decoder or a DNN-based decoder), and may apply the established decoder to the encoder feature data 203 and the sparse encoder feature data 207 to generate a predicted depth map 209. Decoder engine 208 may store the predicted depth map 209 in a data repository, such as system memory 130. An output image, such as a 3D image, may be rendered based on the predicted depth map 209.

In some instances, sparse encoder engine 206 provides skip connections 250 to decoder engine 208. For example, sparse encoder engine 206 may provide an output of one or more layers (e.g., convolutional layers) of the established encoder to decoder engine 208, and decoder engine 208 may provide the one or more outputs as inputs to corresponding layers (e.g., convolutional layers) of the established decoder. In this example, decoder engine 208 may generate the predicted depth map 209 based on the encoder feature data 203, the sparse encoder feature data 207, and the skip connections 250.

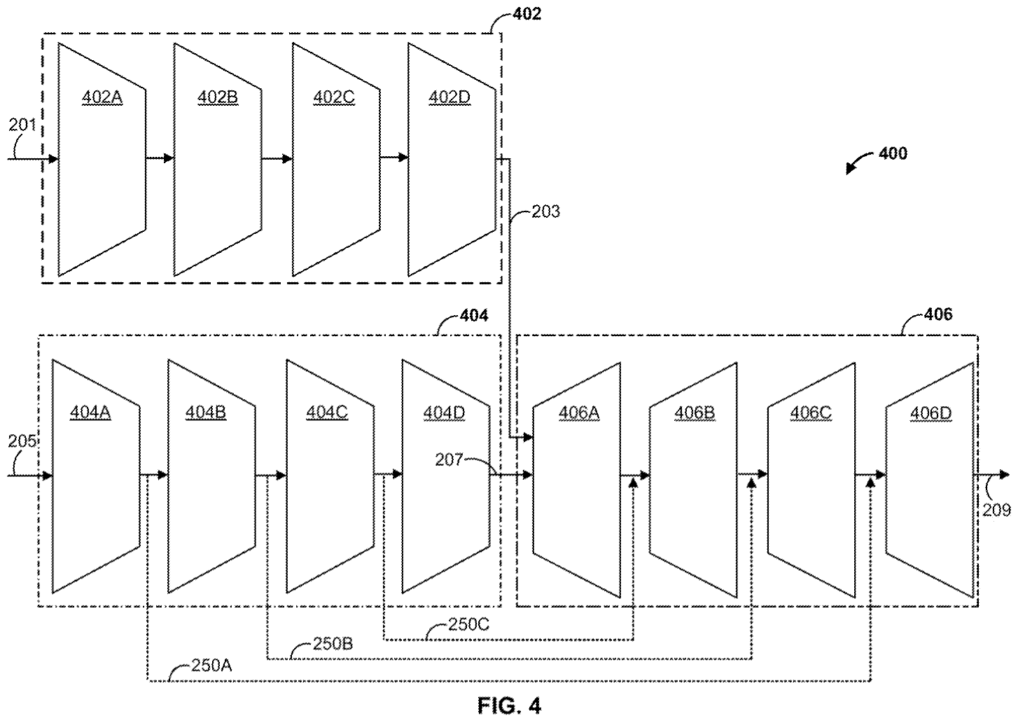

For instance, FIG. 4 illustrates a machine learning model 400 that includes an image encoder 402, a sparse encoder 404, and a decoder 406. Image encoder 402 includes multiple convolutional layers, such as convolutional layers 402A, 402B, 402C, and 402D. Although four convolutional layers are illustrated, the number of convolutional layers may be greater than four, or less than four, in some embodiments. Image encoder 402 may receive input image data 201, and may apply the first convolutional layer 402A to the input image data 201 to generate a first layer output. Image encoder 402 may then apply the second convolutional layer 402B to the first layer output to generate a second layer output. Similarly, image encoder 402 may apply the third convolutional layer 402C to the second layer output to generate a third layer output, and apply the fourth convolutional layer 402D to the third layer output to generate the encoder feature data 203.

Although not illustrated for simplicity, image encoder 402 may also include corresponding non-linearity layers (e.g., sigmoid, rectified linear unit (ReLU), etc.) and pooling layers. For instance, the fourth output may pass through a pooling layer to generate the encoder feature data 203.

Sparse encoder 404 also includes multiple convolutional layers, such as convolutional layers 404A, 404B, 404C, and 404D. Although four convolutional layers are illustrated, the number of convolutional layers may be greater than four, or less than four, in some embodiments. Sparse encoder 404 may receive sparse depth map 205, and may apply the first convolutional layer 404A to the sparse depth map 205 to generate a first layer output. Sparse encoder 404 may then apply the second convolutional layer 404B to the first layer output to generate a second layer output. Similarly, sparse encoder 404 may apply the third convolutional layer 404C to the second layer output to generate a third layer output, and apply the fourth convolutional layer 404D to the third layer output to generate a fourth layer output, sparse encoder feature data 207.

Although not illustrated for simplicity, sparse encoder 404 may also include corresponding non-linearity layers (e.g., sigmoid, rectified linear unit (ReLU), etc.) and pooling layers. For instance, the fourth layer output may pass through a pooling layer to generate the sparse encoder feature data 207.

Further, each output of the convolutional layers 404A, 404B, 404C, and 404D are passed as skip connections to corresponding layers of decoder 406. As illustrated, decoder 406 includes multiple convolutional layers including convolutional layers 406A, 406B, 406C, and 406D. Although four convolutional layers are illustrated, the number of convolutional layers may be greater than four, or less than four, in some embodiments. Decoder 406 receives encoder feature data 203 from the encoder 402 and sparse encoder feature data 207 from sparse encoder 404, and applies the first convolutional layer 406A to the encoder feature data 203 and the sparse encoder feature data 207 to generate a first layer output.

Further, the output of the first convolutional layer 404A of sparse encoder 404 is provided as a skip connection input 250A to the fourth convolutional layer 406D of decoder 406. Similarly, the output of the second convolutional layer 404A of sparse encoder 404 is provided as skip connection input 250B to the third convolutional layer 406C of decoder 406. Further, the output of the third convolutional layer 404C of sparse encoder 404 is provided as skip connection input 250C to the second convolutional layer 406B of decoder 406. Although three skip connections are illustrated, in some embodiments, the number of skip connections may be greater than, or less than, three. Further, at least in some embodiments, the sparse encoder 404 and the decoder 406 include the same number of convolutional layers. In some embodiments, the sparse encoder 404 may include more or less convolutional layers than the decoder 406.

As such, first convolutional layer 406A generates a first layer output based on encoder feature data 203 and sparse encoder feature data 207. The second convolutional layer 406B generates a second layer output based on the first layer output and the skip connection input 250C. The third convolutional layer 406C generates a third layer output based on the second layer output and the skip connection input 250B. Finally, the fourth convolutional layer 406D generates a fourth layer output, the predicted depth map 209, based on the third layer output and the skip connection input 250A.

Although not illustrated for simplicity, decoder 406 may also include corresponding non-linearity layers (e.g., sigmoid, rectified linear unit (ReLU), etc.) and upsampling layers, as well as flatten, fully connected, and softmax layers. For instance, the fourth layer output of the fourth convolutional layer 406D may pass through flatten, fully connected, and softmax layers before being provided as the predicted depth map 209. In some examples, decoder 406 may receive skip connections from image encoder 402, either in addition to, or alternate to, the skip connections 250A, 250B, 250C received from the sparse encoder 404.

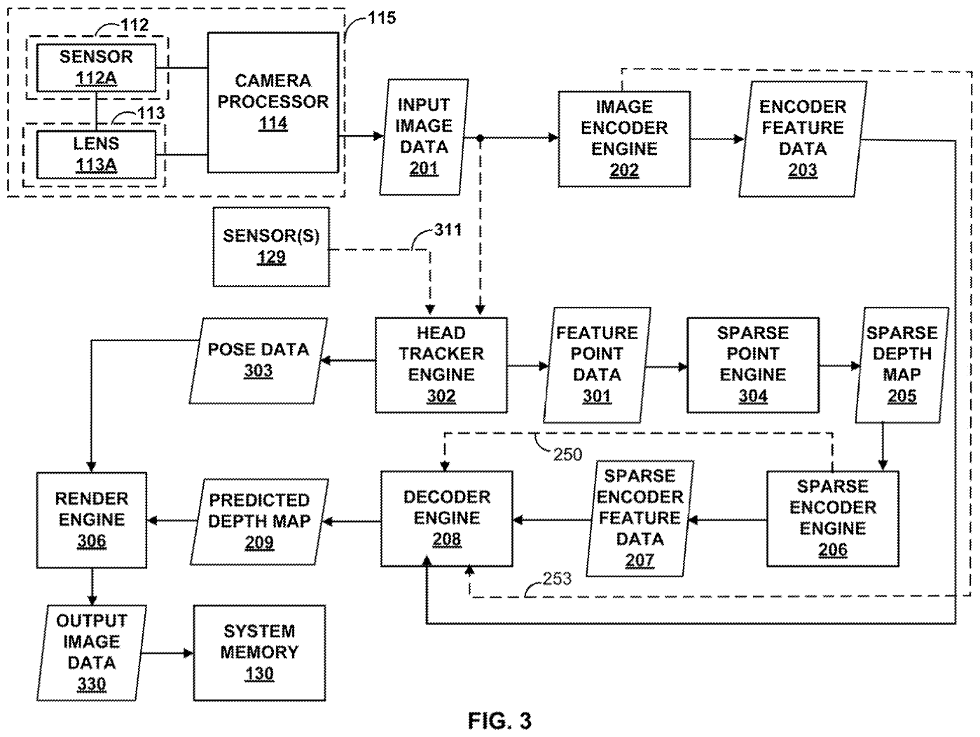

FIG. 3 is a diagram illustrating exemplary portions of the imaging device 100 of FIG. 1. In this example, imaging device 100 includes camera 115, encoder engine 202, sparse encoder engine 206, decoder engine 208, head tracker engine 220, sparse point engine 225, and render engine 230. As described herein, in some examples, each of image encoder engine 202, sparse encoder engine 206, decoder engine 208, head tracker engine 302, sparse point engine 304, and render engine 306 may include instructions that, when executed by one or more of camera processor 114, CPU 116, and GPU 118, cause the one or more of camera processor 114 CPU 116, and GPU 118 to perform corresponding operations. For example, and as described herein, image encoder engine 202 may include encoder model data 132A, sparse encoder engine 206 may include sparse encoder model data 132B, and decoder engine 208 may include decoder model data 132C. Further, head tracker engine 302 may include head tracker model data 132D, and render engine 306 may include render model data 132E.

In some examples, one or more of image encoder engine 202, sparse encoder engine 206, decoder engine 208, head tracker engine 302, sparse point engine 304, and render engine 306 may be implemented in hardware, such as within one or more FPGAs, ASICs, digital circuitry, or any other suitable hardware or hardware or hardware and software combination.

In this example, camera 115 captures an image, such as an image of a field-of-view of one of sensors 112 through a corresponding lens 113A. Camera processor 114 may generate input image data 201 characterizing the captured image, and provide input image data 201 to encoder engine 202 and head tracker engine 220. In some examples, input image data 201 may characterize a color image. For example, the image may include red, green, and blue channels, with each channel include pixels for the image for the corresponding color. In some examples, input image data 201 characterizes a monochrome image. For example, the monochrome image may include grayscale pixel values for a single channel or grayscale pixel values for each of multiple channels, such as grayscale pixel values for corresponding red, green, and blue channels.

As described herein, encoder engine 202 may receive input image data 201, and may apply an established encoding process to the input image data 201 to generate encoder feature data 203 characterizing a set of image features. Further, head tracker engine 302 may apply one or more processes to the input image data 201 and, in some examples, to sensor data 311 from one or more sensors 129 (e.g., accelerometer data, gyroscope data, etc.), to generate feature point data 301 characterizing image features, and may also generate pose data 303 characterizing a user's pose. For example, head tracker engine 302 may employ a Harris corner detector to generate feature point data 301 characterizing keypoints. In some instances, feature point data 301 includes 6DoF tracking information as described herein (e.g., 6Dof tracking data). In some examples, head tracker engine 302 applies one or more processes to the sensor data 311 to generate the feature point data 301. The feature point data 301 may be temporally associated with the time camera 115 captured the image. For example, camera 115 may have captured the image at the same time the sensors 129 generated the sensor data 311 from which the feature point data 301 is generated.

Further, sparse point engine 304 may receive feature point data 301 from the head tracker engine 302, and may perform operations to generate a sparse depth map 205. For instance, sparse point engine 304 may perform operations to map the feature point data 301, which may include 6DoF tracking information such as 3D depth information, to two-dimensional space. The sparse depth map 205 may include sparse depth values for the captured image. In some examples, sparse point engine 304 projects 3D feature points from the 6DoF tracking information to two dimensions to generate the sparse depth map 205.

Further, and as described herein, sparse encoder engine 206 may receive sparse depth map 205 from sparse point engine 304, and may apply an encoding process to the sparse depth map 205 to generate sparse encoder feature data 207 characterizing sparse features of the image. Further, decoder engine 208 may receive sparse encoder feature data 207 from sparse encoder engine 206, and may apply a decoding process to the sparse encoder feature data 207 to generate a predicted depth map 209. For example, decoder engine 208 may apply a trained decoder of a neural network, such as a CNN-based decoder or a DNN-based decoder, to the sparse encoder feature data 207 to generate the predicted depth map 209. In some instances, sparse encoder engine 206 provides skip connections 250 to decoder engine 208. In these examples, decoder engine 208 provides the skip connections 250 to corresponding layers of the established decoding process, and generates the predicted depth map 209, as described herein. In some instances, image encoder engine 202 provides skip connections 253 to decoder engine 208, either in addition to, or alternate to, the skip connections from sparse encoder engine 206. In these examples, decoder engine 208 provides the skip connections 250 to corresponding layers of the established decoding process and generates the predicted depth map 209.

Render engine 306 may receive the predicted depth map 209 from the decoder engine 208, as well as the pose data 303 from head tracker engine 302. Render engine 306 may apply a rendering process to the predicted depth map 209 and the pose data 303 to generate output image data 300 charactering an output image, such as a 3D image. For example, render engine may apply a mesh rendering process to the predicted depth map 209 and the pose data 303 to generate mesh data characterizing a mesh of the image, and may perform one or more plane estimation processes to generate plane data characterizing one or more planes based on the mesh data. The output image data 330 may include one or more of the mesh data and the plane data, for instance. Render engine 306 may store the output image data 330 in a data repository, such as within system memory 130.

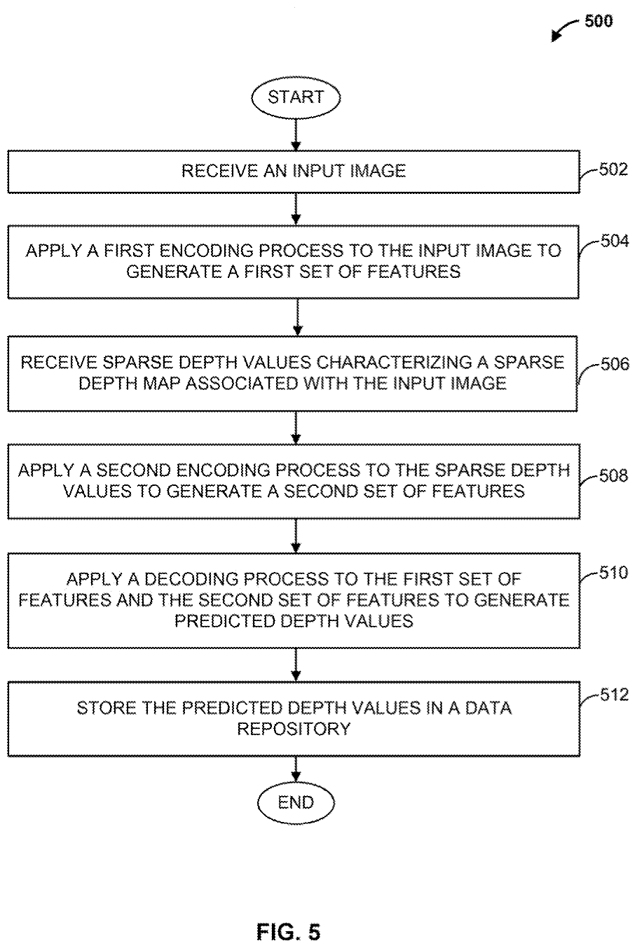

FIG. 5 is a flowchart of an exemplary process 500 for determining depth values for objects within an image. For example, one or more computing devices, such as imaging device 100, may perform one or more operations of exemplary process 500, as described below in reference to FIG. 5.

Referring to FIG. 5, imaging device 100 may perform, at block 502, any of the processes described herein to receive an input image. For example, a camera 115 of imaging device 100 may capture an image within its field-of-view. The image may be, for example, of an environment of a user of the imaging device 100 (e.g., a gamer wearing a VR headset). At block 504, imaging device 100 may perform any of the processes described herein to apply a first encoding process to the input image to generate a first set of features. For instance, imaging device 100 may establish a trained CNN or DNN-based encoder, and may apply the trained encoder to the input image to generate image features.

Further, at block 506, imaging device 100 may perform any of the processes described herein to receive sparse depth values characterizing a sparse depth map temporally associated with the input image. For example, imaging device 100 may receive a sparse depth map, such as sparse depth map 205, which characterizes sparse depth values, and temporally associated with an image captured by camera 115. At block 508, imaging device 100 may perform any of the processes described herein to apply a second encoding process to the sparse depth values to generate a second set of features. For instance, imaging device 100 may establish a trained encoder of a neural network (e.g., such as a CNN or DNN-based encoder), and may apply the trained encoder to the sparse depth values to generate sparse features.

Proceeding to block 510, imaging device 100 may perform any of the processes described herein to apply a decoding process to the first set of features and the second set of features to generate predicted depth values. For example, as described herein, imaging device 100 may establish a trained decoder of a neural network (e.g., such as a CNN-based decoder or a DNN-based decoder), and may apply the trained decoder to the first set of features and the second set of features to generate a predicted depth map, such as predicted depth map 209, that characterizes predicted depth values for the image. In some instances, the second encoding process provides skip connections to the decoding process for determining the predicted depth values, as described herein.

At block 512, imaging device 100 may perform any of the processes described herein to store the predicted depth values in a data repository. For instance, imaging device 100 may store the predicted depth values (e.g., predicted depth map 209) in system memory 130. As described herein, imaging device 100, or another computing device, may generate an output image, such as a 3D image, based on the predicted depth values, and may provide the output image for display.

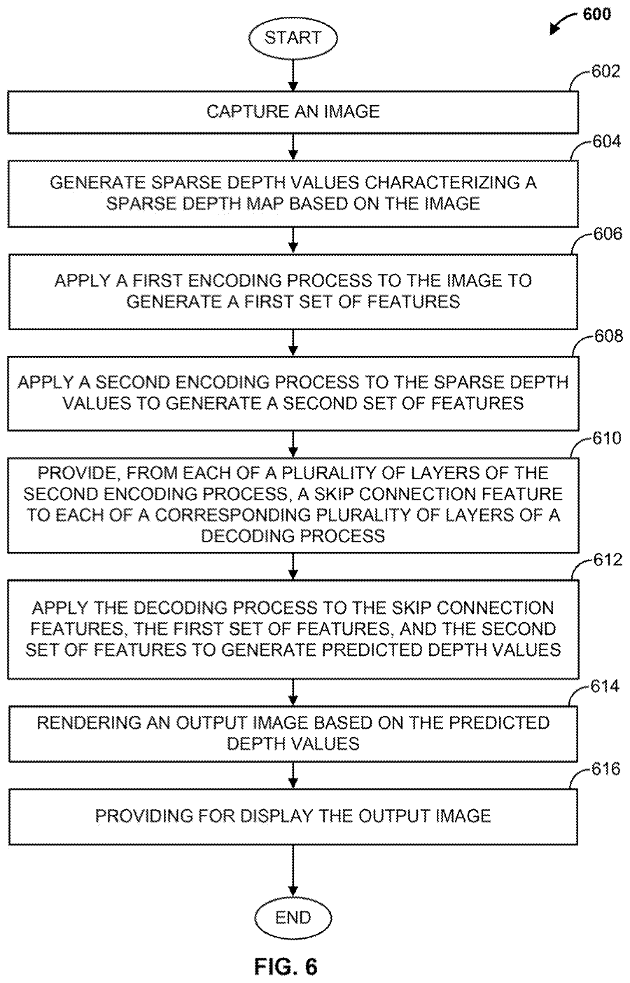

FIG. 6 is a flowchart of an exemplary process 600 for rendering an image based on determined depth values. For example, one or more computing devices, such as imaging device 100, may perform one or more operations of exemplary process 600, as described below in reference to FIG. 6.

Beginning at block 602, imaging device 100 may perform any of the processes described herein to capture an image (e.g., using camera 115). At block 604, imaging device 100 may perform any of the processes described herein to generate, based on the image, sparse depth values characterizing a sparse depth map. Further, and at block 606, imaging device 100 may perform any of the processes described herein to apply a first encoding process (e.g., an encoding process by encoder engine 202) to the image to generate a first set of features. At block 608, imaging device 100 may perform any of the processes described herein to apply a second encoding process (e.g., an encoding process by sparse encoder engine 206) to the sparse depth values to generate a second set of features.

Proceeding to block 610, imaging device 100 may perform any of the processes described herein to provide, from each of a plurality of layers of the second encoding process, a skip connection feature (e.g., skip connections 250) to each of a corresponding plurality of layers of a decoding process (e.g., a decoding process by decoder engine 208).

At block 612, imaging device 100 may perform any of the processes described herein to apply the decoding process to the skip connection features, the first set of features, and the second set of features to generate predicted depth values. For example, and as described herein, imaging device 100 may decode encoder feature data 203 and sparse encoder feature data 207 to generate the predicted depth map 209.

Further, and at block 614, imaging device 100 may perform any of the processes described herein to render an output image based on the predicted depth values. For example, as described herein, render engine 306 may generate output image data 330 based on the predicted depth map 209 and, in some instance, based further on pose data 303. At clock 616, imaging device 100 may perform any of the processes described herein to provide for display the output image. For example, imaging device 100 may provide the output image to display interface 126 for display on display 128.

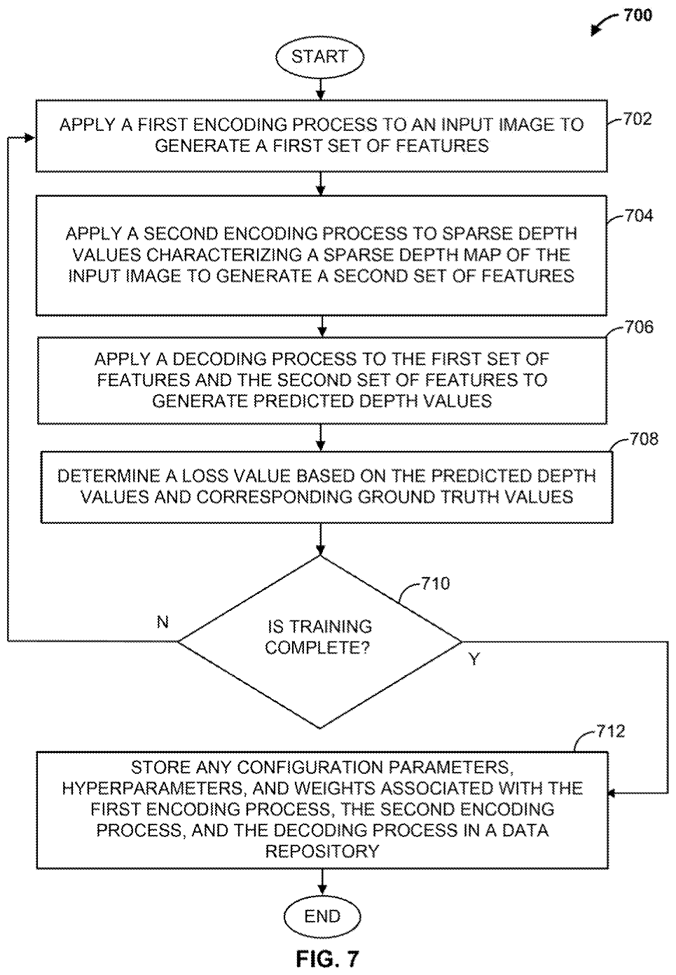

FIG. 7 is a flowchart of an exemplary process 600 for training a machine learning process. For example, one or more computing devices, such as imaging device 100, may perform one or more operations of exemplary process 700, as described below in reference to FIG. 7.

Beginning at block 702, imaging device 100 may perform any of the processes described herein to apply a first encoding process to an input image to generate a first set of features. The input image may be a training image obtained from a training set of images stored in a data repository, such as system memory 130. At block 704, imaging device 100 may perform any of the processes described herein to apply a second encoding process to sparse depth values to generate a second set of features. The sparse depth values may correspond to a sparse depth map generated for the input image and stored in system memory 130. Further, and at block 706, imaging device 100 may perform any of the processes described herein to apply a decoding process to the first set of features and the second set of features to generate predicted depth values.

Proceeding to block 708, imaging device 100 may determine a loss value based on the predicted depth values and corresponding ground truth values. For example, imaging device 100 may compute values of one or more of berHu, SSIM, Edge, MAE, Mean Variant with MAE, and Mean Variant with berHu, a mean absolute relative error, a root mean squared error, a mean absolute error, an accuracy, a recall, a precision, an F-score, or any other metric. Further, and at block 710, imaging device 100 may determine whether training is complete. For example, imaging device 100 may compare each computed loss value to a corresponding threshold to determine whether training is complete. For instance, if each computed loss value indicates a greater loss than the corresponding threshold, training is not complete, and the process proceeds back to block 702. Otherwise, if each computed loss value indicates no greater a loss than the corresponding threshold, the process proceeds to block 712.

At block 712, imaging device 100 stores any configuration parameters, hyperparameters, and weights associated with the first encoding process, the second encoding process, and the decoding process in a data repository. For example, imaging device 100 may store any configuration parameters, hyperparameters, and weights associated with the first encoding process within encoder model data 132A in instruction memory 132. Similarly, imaging device 100 may store any configuration parameters, hyperparameters, and weights associated with the second encoding process within sparse encoder model data 132B in instruction memory 132. Imaging device 100 may also store any configuration parameters, hyperparameters, and weights associated with the second encoding process within decoder model data 132C in instruction memory 132.

Implementation examples are further described in the following numbered clauses:
1. An apparatus comprising:
a non-transitory, machine-readable storage medium storing instructions; and
at least one processor coupled to the non-transitory, machine-readable storage medium, the at least one processor being configured to execute the instructions to:
   receive three dimensional feature points from a six degrees of freedom (6Dof) tracker;
   generate sparse depth values based on the three dimensional feature points;
   generate predicted depth values based on an image and the sparse depth values; and
   store the predicted depth values in a data repository.
2. The apparatus of clause 1, wherein the at least one processor is configured to execute the instructions to generate an output image based on the predicted depth values.
3. The apparatus of clause 2, wherein the at least one processor is configured to execute the instructions to generate pose data characterizing a pose of a user, and generate the output image based on the pose data.
4. The apparatus of any of clauses 2-3 comprising an extended reality environment, wherein the at least one processor is configured to execute the instructions to provide the output image for viewing in the extended reality environment.
5. The apparatus of any of clauses 1-4, wherein the at least one processor is configured to execute the instructions to:
apply a first encoding process to the image to generate a first set of features;
apply a second encoding process to the sparse depth values to generate a second set of features; and apply a decoding process to the first set of features and the second set of features to generate the predicted depth values.
6. The apparatus of clause 5, wherein the at least one processor is further configured to execute the instructions to provide at least one skip connection from the second encoding process to the decoding process.
7. The apparatus of clause 6, wherein the at least one skip connection comprises a first skip connection and a second skip connection, wherein the at least one processor is configured to execute the instructions to:
provide the first skip connection from a first layer of the second encoding process to a first layer of the decoding process; and
provide a second skip connection from a second layer of the second encoding process to a second layer of the decoding process.
8. The apparatus of any of clauses 5-7, wherein the at least one processor is configured to execute the instructions to:
obtain first parameters from the data repository, and establish the first encoding process based on the first parameters;
obtain second parameters from the data repository, and establish the second encoding process based on the second parameters; and
obtain third parameters from the data repository, and establish the decoding process based on the third parameters.
9. The apparatus of any of clauses 1-8, wherein the image is a monochrome image.
10. The apparatus of any of clauses 1-9 comprising at least one camera, wherein the at least one camera is configured to capture the image.
11. The apparatus of any of clauses 1-10, wherein the three dimensional feature points are generated based on the image.
12. A method for adjusting a lens of an imaging device, the method comprising:
receiving three dimensional feature points from a six degrees of freedom (6Dof) tracker;
generating sparse depth values based on the three dimensional feature points;
generating predicted depth values based on an image and the sparse depth values; and
storing the predicted depth values in a data repository.
13. The method of clause 12, comprising generating an output image based on the predicted depth values.
14. The method of clause 13, comprising generating an output image based on the predicted depth values.
15. The method of any of clauses 13-14, comprising providing the output image for viewing in an extended reality environment.
16. The method of any of clauses 12-15, comprising:
applying a first encoding process to the image to generate a first set of features;
applying a second encoding process to the sparse depth values to generate a second set of features; and
applying a decoding process to the first set of features and the second set of features to generate the predicted depth values.
17. The method of clause 16, comprising providing at least one skip connection from the second encoding process to the decoding process.
18. The method of clause 17, wherein the at least one skip connection comprises a first skip connection and a second skip connection, the method comprising:
providing the first skip connection from a first layer of the second encoding process to a first layer of the decoding process; and
providing a second skip connection from a second layer of the second encoding process to a second layer of the decoding process.
19. The method of any of clauses 17-18, comprising:
obtaining first parameters from the data repository, and establish the first encoding process based on the first parameters;
obtaining second parameters from the data repository, and establish the second encoding process based on the second parameters; and
obtaining third parameters from the data repository, and establish the decoding process based on the third parameters.
20. The method of any of clauses 12-19, wherein the image is a monochrome image.
21. The method of any of clauses 12-20, comprising causing at least one camera to capture the image.
22. The method of any of clauses 12-21, wherein the three dimensional feature points are generated based on the image.
23. A non-transitory, machine-readable storage medium storing instructions that, when executed by at least one processor, causes the at least one processor to perform operations that include:
receiving three dimensional feature points from a six degrees of freedom (6Dof) tracker;
generating sparse depth values based on the three dimensional feature points;
generating predicted depth values based on an image and the sparse depth values; and
storing the predicted depth values in a data repository.
24. The non-transitory, machine-readable storage medium of clause 23, wherein the instructions, when executed by the at least one processor, causes the at least one processor to perform operations that include generating an output image based on the predicted depth values.
25. The non-transitory, machine-readable storage medium of clause 24, wherein the instructions, when executed by the at least one processor, causes the at least one processor to perform operations that include generating an output image based on the predicted depth values.
26. The non-transitory, machine-readable storage medium of any of clauses 24-25, wherein the instructions, when executed by the at least one processor, causes the at least one processor to perform operations that include providing the output image for viewing in an extended reality environment.
27. The non-transitory, machine-readable storage medium of any of clauses 23-26, wherein the instructions, when executed by the at least one processor, causes the at least one processor to perform operations that include:
applying a second encoding process to the sparse depth values to generate a second set of features; and applying a decoding process to the first set of features and the second set of features to generate the predicted depth values.
28. The non-transitory, machine-readable storage medium of clause 27, wherein the instructions, when executed by the at least one processor, causes the at least one processor to perform operations that include providing at least one skip connection from the second encoding process to the decoding process.
29. The non-transitory, machine-readable storage medium of clause 28, wherein the instructions, when executed by the at least one processor, causes the at least one processor to perform operations that include:
providing the first skip connection from a first layer of the second encoding process to a first layer of the decoding process; and
providing a second skip connection from a second layer of the second encoding process to a second layer of the decoding process.
30. The non-transitory, machine-readable storage medium of any of clauses 28-29, wherein the instructions, when executed by the at least one processor, causes the at least one processor to perform operations that include:
obtaining first parameters from the data repository, and establishing the first encoding process based on the first parameters;
obtaining second parameters from the data repository, and establishing the second encoding process based on the second parameters; and
obtaining third parameters from the data repository, and establishing the decoding process based on the third parameters.
31. The non-transitory, machine-readable storage medium of any of clauses 23-30, wherein the image is a monochrome image.
32. The non-transitory, machine-readable storage medium of any of clauses 23-31, wherein the instructions, when executed by the at least one processor, causes the at least one processor to perform operations that include causing at least one camera to capture the image.
33. The non-transitory, machine-readable storage medium of any of clauses 23-32, wherein the three dimensional feature points are generated based on the image.
34. An image capture device comprising:
a means for receiving three dimensional feature points from a six degrees of freedom (6Dof) tracker;
a means for generating sparse depth values based on the three dimensional feature points;
a means for generating predicted depth values based on an image and the sparse depth values; and
a means for storing the predicted depth values in a data repository.
35. The image capture device of clause 34, comprising a means for generating an output image based on the predicted depth values.
36. The image capture device of clause 35, comprising a means for generating an output image based on the predicted depth values.
37. The image capture device of any of clauses 35-36, comprising a means for generating an output image based on the predicted depth values.
38. The image capture device of any of clauses 34-37, comprising:
a means applying a first encoding process to the image to generate a first set of features;
a means applying a second encoding process to the sparse depth values to generate a second set of features; and
a means applying a decoding process to the first set of features and the second set of features to generate the predicted depth values.
39. The image capture device of clause 38, comprising a means for providing at least one skip connection from the second encoding process to the decoding process.
40. The image capture device of clause 39, wherein the at least one skip connection comprises a first skip connection and a second skip connection, the image capture device comprising:
a means for providing the first skip connection from a first layer of the second encoding process to a first layer of the decoding process; and
a means for providing a second skip connection from a second layer of the second encoding process to a second layer of the decoding process.
41. The image capture device of any of clauses 39-40, comprising:
a means for obtaining first parameters from the data repository, and establishing the first encoding process based on the first parameters;
a means for obtaining second parameters from the data repository, and establishing the second encoding process based on the second parameters; and
a means for obtaining third parameters from the data repository, and establishing the decoding process based on the third parameters.
42. The image capture device of any of clauses 34-41, wherein the image is a monochrome image.
43. The image capture device of any of clauses 34-42, comprising a means for causing at least one camera to capture the image.
44. The image capture device of any of clauses 34-43, wherein the three dimensional feature points are generated based on the image.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

We claim:

1. An apparatus comprising:
a non-transitory, machine-readable storage medium storing instructions; and
at least one processor coupled to the non-transitory, machine-readable storage medium, the at least one processor being configured to execute the instructions to:
receive three dimensional feature points from a six degrees of freedom (6Dof) tracker;
generate sparse depth values based on the three dimensional feature points;
generate predicted depth values based on an image and the sparse depth values; and
store the predicted depth values in a data repository.

2. The apparatus of claim 1, wherein the at least one processor is configured to execute the instructions to generate an output image based on the predicted depth values.

3. The apparatus of claim 2, wherein the at least one processor is configured to execute the instructions to generate pose data characterizing a pose of a user, and generate the output image based on the pose data.

4. The apparatus of claim 2 comprising an extended reality environment, wherein the at least one processor is configured to execute the instructions to provide the output image for viewing in the extended reality environment.

5. The apparatus of claim 1, wherein the at least one processor is further configured to execute the instructions to:
apply a first encoding process to the image to generate a first set of features;
apply a second encoding process to the sparse depth values to generate a second set of features; and
apply a decoding process to the first set of features and the second set of features to generate the predicted depth values.

6. The apparatus of claim 5, wherein the at least one processor is further configured to execute the instructions to provide at least one skip connection from the second encoding process to the decoding process.

7. The apparatus of claim 6, wherein the at least one skip connection comprises a first skip connection and a second skip connection, wherein the at least one processor is configured to execute the instructions to:
provide the first skip connection from a first layer of the second encoding process to a first layer of the decoding process; and
provide a second skip connection from a second layer of the second encoding process to a second layer of the decoding process.

8. The apparatus of claim 5, wherein the at least one processor is configured to execute the instructions to:
obtain first parameters from the data repository, and establish the first encoding process based on the first parameters;
obtain second parameters from the data repository, and establish the second encoding process based on the second parameters; and
obtain third parameters from the data repository, and establish the decoding process based on the third parameters.

9. The apparatus of claim 1, wherein the image is a monochrome image.

10. The apparatus of claim 1 comprising at least one camera, wherein the at least one camera is configured to capture the image.

11. The apparatus of claim 1, wherein the three dimensional feature points are generated based on the image.

12. A method for adjusting a lens of an imaging device, the method comprising:
receiving three dimensional feature points from a six degrees of freedom (6Dof) tracker;
generating sparse depth values based on the three dimensional feature points;
generating predicted depth values based on an image and the sparse depth values; and
storing the predicted depth values in a data repository.

13. The method of claim 12, comprising generating an output image based on the predicted depth values.

14. The method of claim 13, comprising generating an output image based on the predicted depth values.

15. The method of claim 13, comprising providing the output image for viewing in an extended reality environment.

16. The method of claim 12, comprising:
applying a first encoding process to the image to generate a first set of features;
applying a second encoding process to the sparse depth values to generate a second set of features; and
applying a decoding process to the first set of features and the second set of features to generate the predicted depth values.

17. The method of claim 16, comprising providing at least one skip connection from the second encoding process to the decoding process.

18. The method of claim 17, wherein the at least one skip connection comprises a first skip connection and a second skip connection, the method comprising:
providing the first skip connection from a first layer of the second encoding process to a first layer of the decoding process; and
providing a second skip connection from a second layer of the second encoding process to a second layer of the decoding process.

19. The method of claim 17, comprising:
obtaining first parameters from the data repository, and establish the first encoding process based on the first parameters;
obtaining second parameters from the data repository, and establish the second encoding process based on the second parameters; and
obtaining third parameters from the data repository, and establish the decoding process based on the third parameters.

20. A non-transitory, machine-readable storage medium storing instructions that, when executed by at least one processor, causes the at least one processor to perform operations that include:
receiving three dimensional feature points from a six degrees of freedom (6Dof) tracker;
generating sparse depth values based on the three dimensional feature points;
generating predicted depth values based on an image and the sparse depth values; and
storing the predicted depth values in a data repository.
